(19) United States
(12) Patent Application Publication
(10) Pub. No.: US 2010/0182389 A1
(43) Pub. Date: Jul. 22, 2010

(54) MEDIA INTERFACE MODULE AND PRINTER WITH A MEDIA WIPER

(76) Inventor: Kenneth Dobizl, Brooklyn Pard, MN (US)

Correspondence Address: QUARLES & BRADY LLP, 411 E. WISCONSIN AVENUE, SUITE 2040, MILWAUKEE, WI, 53202-4497, US

(21) Appl. No.: 12/355,595

(22) Filed: Jan. 16, 2009

(51) Int. Cl. B41J 2/01

(52) U.S. Cl. 347/104

(57) ABSTRACT

A printer assembly comprises a printer frame, a media interface module disposed in the printer frame, media disposed in the media interface module and dispensed from the media interface module into the printer frame, a wiper member supported by one of the printer frame and the media interface module, and a wiper pad carried by the wiper member and engaging the media to remove debris from the media. In other forms, a media interface module comprises media disposed in the media interface module, a wiper member supported by the media interface module, and a wiper pad carried by the wiper member and engaging the media to remove debris from the media as the media is dispensed form the media interface module.

### CROSS REFERENCES TO RELATED APPLICATIONS

Not Applicable.

### STATEMENT REGARDING FEDERALLY SPONSORED RESEARCH

Not Applicable.

### BACKGROUND OF THE INVENTION

The present invention relates to printers, and more particularly to a media interface module and a printer with a media wiper assembly.

Most printers include a print head that transfers ink onto a media. In general, the print quality is influenced by the cleanliness of the print head and the media onto which the printer is printing. If contaminated media is fed into a printer and directed adjacent the print head, debris (e.g., dust) on the media tends to build up on the print head, ultimately degrading the performance of the print head and the resulting print quality (e.g., causing streaks and voids on the resulting print). As a result, the print head is routinely cleaned to remove built-up debris in an attempt to maintain a high-quality print.

Cleaning the print head is a time consuming and tedious process that often involves the operator removing several components in order to gain access to the print head. The repeated cleaning of the print head may reduce the ultimate lifespan of the print head and/or impart excessive wear on various components within the printer.

Even if the print head is essentially free of debris, debris on the media can negatively influence the ultimate quality of the resulting print. Debris located on a print surface of the media degrades the quality of the print as ink is not effectively transferred to the print surface by the print head. If ink is transferred to debris on the print surface and that debris is later removed from the print surface, a void is created in the print. Additionally, the debris creates an uneven surface that distorts the print and may result in the ink wicking beyond the desired print area.

Another inconvenience common in printers occurs when an operator desires to change the type, size, or general form factor of the media. Even if the new media is capable of engaging the printer, aligning the media in the printer and securing it therein can be a burdensome task. Also, if the new media is of a different type or size, it may not be compatible with the printer. That is, a special adapter may be required (e.g., a spool extension) or the new media may simply not be compatible with the printer, thus requiring an entirely different printer to print on the new media. As a result, exchanging or swapping media types in most printers, if even possible, is often a time consuming and involved process.

In light of at least the above considerations, a need exists for a device for removing or reducing the amount of debris on a print surface of a media, and a device for facilitating the exchange of media in a printer.

### SUMMARY OF THE INVENTION

In one aspect, a printer assembly comprises a printer frame, a media interface module disposed in the printer frame, media disposed in the media interface module and dispensed from the media interface module into the printer frame, a wiper member supported by one of the printer frame and the media interface module, and a wiper pad carried by the wiper member and engaging the media to remove debris from the media.

In another aspect, a media interface module comprises media disposed in the media interface module, a wiper member supported by the media interface module, and a wiper pad carried by the wiper member and engaging the media to remove debris from the media as the media is dispensed form the media interface module.

These and still other aspects of the invention will be apparent from the description that follows. In the detailed description, preferred example embodiments of the invention will be described with reference to the accompanying drawings. These embodiments do not represent the full scope of the invention; rather, the invention may be employed in other embodiments. Reference should therefore be made to the claims herein for interpreting the breadth of the invention.

### BRIEF DESCRIPTION OF THE DRAWINGS

FIG. 1 is a perspective view of an example printer frame incorporating an aspect of the invention;

FIG. 2 is a partial, front exploded view of the example device shown in FIG. 1;

FIG. 3 is a partial, rear exploded view of the example device shown in FIG. 1;

FIG. 4 is an exploded view of an example media wiper assembly and media interface module;

FIG. 5 is a partial section view along line 5-5 of FIG. 1 showing a portion of the example media wiper assembly and media interface module;

FIG. 6 is a partial section view along line 6-6 of FIG. 1 showing a portion of the example media wiper assembly in an engaged position;

FIG. 7 is a partial section view along line 6-6 of FIG. 1 showing a portion of the example media wiper assembly in another engaged position;

FIG. 8 is partial detailed view of the portion circumscribed by arc 8-8 of FIG. 6;

FIG. 9 is partial detailed view of the portion circumscribed by arc 9-9 of FIG. 6;

FIG. 10 is a partial section view along line 6-6 of FIG. 1 showing a portion of the example media wiper assembly in a disengaged position;

FIG. 11 is a partial section view of an alternative media wiper assembly and media interface module in accordance with another aspect of the invention; and

FIG. 12 is a partial section view of another alternative media wiper assembly and media interface module in accordance with a further aspect of the invention.

### DETAILED DESCRIPTION OF THE PREFERRED EXAMPLE EMBODIMENT

The preferred example embodiment of the invention will be described in relation to a thermal transfer printer. However, the present invention is equally applicable to other types and styles of printers (e.g., ink jet, wax, etc.) that may benefit from the incorporation of a media wiper and/or a media interface module.

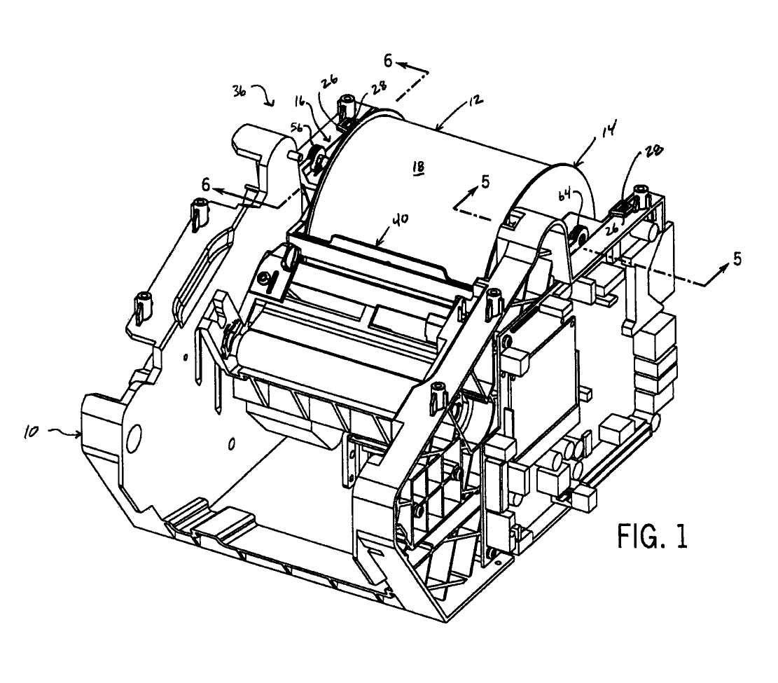

With initial reference to FIG. 1, a portion of a thermal transfer printer is depicted. Specifically, a printer frame 10 is shown removed from the balance of a printer (not shown) that supports various printing components, including a media 12 wound around a spool assembly 14. The media 12 may take a variety of forms, for example, the media 12 may be in the form of rolls, sheets, and the like, and may consist of adhesive labels, plastic transparencies, felt, fabric, or any other printable media. One skilled in the art will appreciate the variety of arrangements, configurations, and types of media 12 that are compatible with the present disclosure.

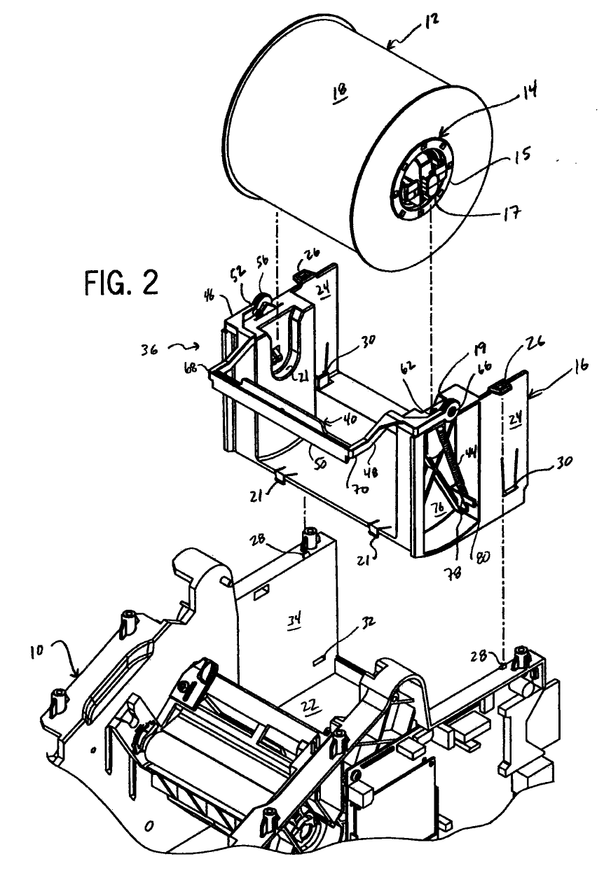

With additional reference to FIG. 2, the spool assembly 14 is seated in a media interface module 16. The media 12 is unwound and dispensed from the spool assembly 14 during a printing operation and fed downstream toward a print head (removed for clarity). The print head transfers ink from a ribbon cartridge (not shown) to a print surface 18 of the media 12 as is understood by one of ordinary skill in the art. As a result, in a typical printer arrangement, debris on the print surface 18 is directed proximate the print head and ribbon cartridge where the debris degrades the printing process.

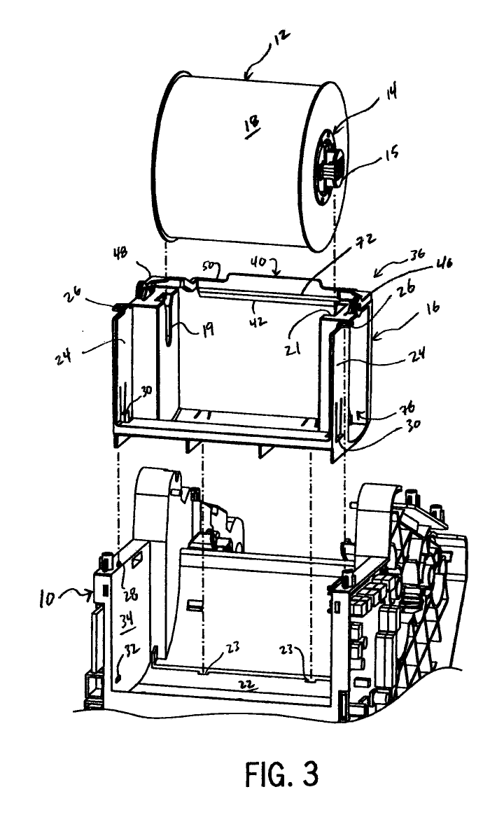

As best illustrated in FIGS. 2 and 3, the media interface module 16 captures the media 12 (and, in the example embodiment, the spool assembly 14) and is also releasably coupleable to the printer frame 10. The spool 15 of the spool assembly 14 includes a protrusion 17 that engages a mating recess 19 formed in the media interface module 16 to align and secure the spool 15 to the media interface module 16 (the media 12, however, is free to rotate relative to the media interface module 16). The end of the spool 15 opposite of the protrusion 17 is seated in a pocket 21 formed in the media interface module 16. One skilled in the art will appreciate the various configurations capable of engaging the spool assembly 14 and the media interface module 16. Alternatively, where sheet or some other form factor of media is incorporated, a spool assembly 14 is not necessary and an alternative feeding mechanism is used.

The media interface module 16 of the example embodiment includes a pair of resilient positioning tabs 20 that engage mating openings 23 in the floor 22 of the printer frame 10. The side walls 24 of the media interface module 16 include positioning brackets 26 extending laterally from the upper portion of the media interface module 16. The positioning brackets 26 align with and engage nibs 28 formed in the printer frame 10 (best shown in FIG. 2). Aligning the positioning tabs 20 and positioning brackets 26 allows the media interface module 16 to be received in the printer frame 10. Additional resilient mounting tabs 30 are formed in the side walls 24 of the media interface module 16 and releasably engage openings 32 formed in respective side walls 34 of the printer frame 10 when the media interface module 16 is coupled to the printer frame 10. As a result, the media 12 may be loaded or secured to the media interface module 16 and then the media interface module 16 releasably engaged with the printer frame 10. Should the operator require a different type, style, or form factor of media 12, the entire media interface module 16 may be removed from the printer frame 10 by deforming the resilient mounting tabs 30 and lifting the media interface module 16 from the printer frame 10. A different media 12, pre-loaded in a different media interface module 16, may then be aligned and engaged with the printer frame 10.

The media interface module 16 may take on a variety of form factors depending upon the media 12 which it is to carry, the configuration of the printer frame 10 into which the media interface module 16 is configured to engage, and any other pertinent design limitations. In the example embodiment, the media interface module 16 is formed of a plastic, thereby allowing the positioning tabs 20, the positioning brackets 26, and resilient mounting tabs 30 to be integrally formed with the balance of the media interface module 16. Given the benefit of this disclosure, one skilled in the art will appreciate the various form factors and configurations available to design and couple a media interface module 16 to a printer frame 10.

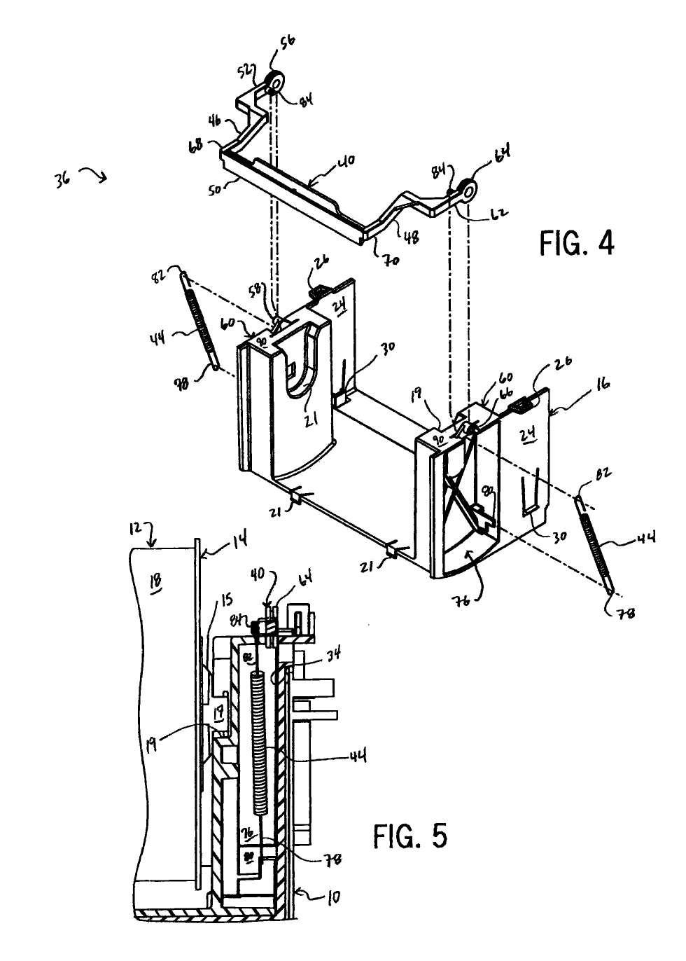

With additional reference to FIG. 4, an example media wiper assembly 36 is shown removed from the printer frame 10. The media wiper assembly 36 of the preferred example embodiment broadly includes the media interface module 16, a wiper member 40 supported by the media interface module 16, a wiper pad 42 carried by the wiper member 40, and a biasing member 44 that biases the wiper pad 42 toward the print surface 18 of the media 12. Alternatively, the wiper member 40 may be carried by or integral with the printer frame 10 or any part thereof (e.g., a cover) that is suitable to carry and implement the wiper member 40.

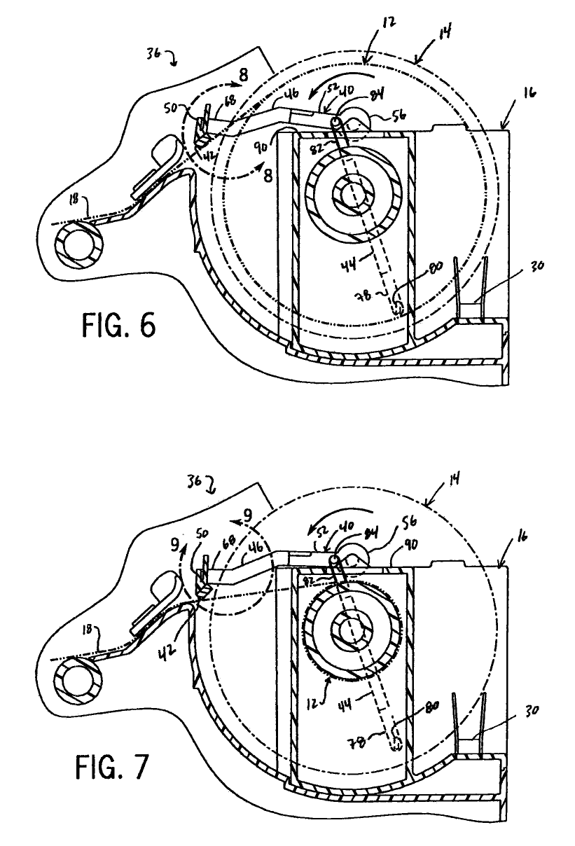

Returning to the example embodiment, the wiper member 40 is preferably pivotally mounted to the media interface module 16 to allow the wiper member 40 to be pivoted between an engaged position (shown best in FIGS. 6-9) and a disengaged position (shown in FIG. 10). However, as will be described, the wiper member 40 need not be pivotally mounted to the media interface module 16 (or the printer frame 10).

The example wiper member 40 includes a first arm 46, a second arm 48, and a wiper support 50 extending between the first arm 46 and the second arm 48. The first arm 46 defines a first proximal end 52 that is pivotally coupled to the media interface module 16. Specifically, the first proximal end 52 defines a generally circular first eyelet 56 that is sized to engage a first hub 58 that extends laterally away from the media interface module 16 proximate an upper portion 60 of the media interface module 16. Similarly, the second arm 48 defines a second proximal end 62 having a generally circular second eyelet 64 sized to engage a second hub 66 extending laterally away from the media interface module 16 proximate the upper portion 60 of the media interface module 16.

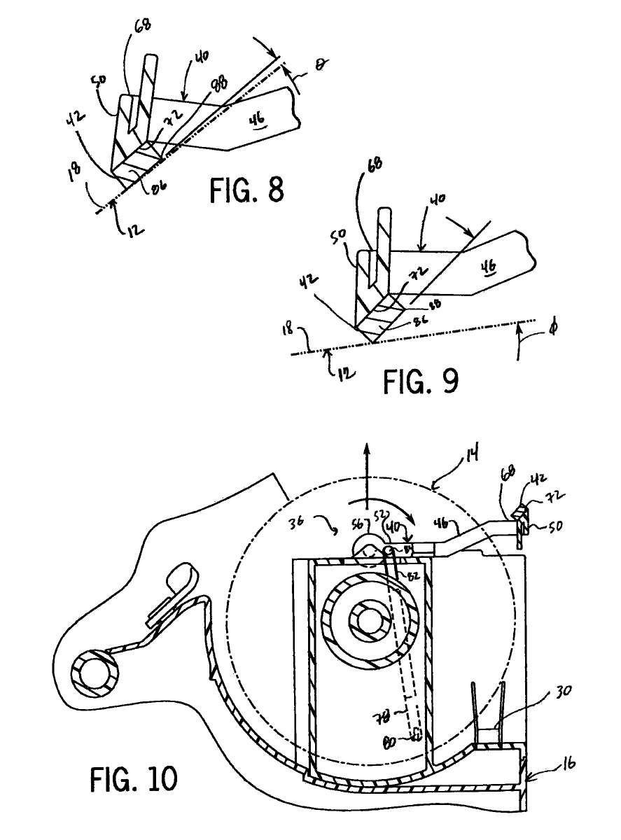

The wiper support 50 extending between the first arm 46 and the second arm 48 is secured between a first distal end 68 of the first arm 46 and a second distal end 70 of the second arm 48. As shown, the wiper support 50 is preferably integrally formed with the first arm 46 and the second arm 48. The wiper support 50 carries the wiper pad 42, and preferably, the wiper pad 42 is adhered to an engagement side 72 of the wiper support 50 such that the wiper pad 42 is brought into contact with the media 12 when the media wiper assembly 36 is in the engaged position (see, for example, FIG. 8). Alternatively, the wiper pad 42 may be clipped, hooked, and the like to the wiper support 50, or when the wiper pad 42 has sufficient structural rigidity, the wiper pad 42 may also be considered the wiper support 50 and be directly coupled to the first arm 46 and the second arm 48.

The wiper member 40 is pivotally coupled to the media interface module 16 by flexing the first arm 46 and the second arm 48 over the respective first hub 58 and the second hub 66, thereby aligning the first eyelet 56 and the second eyelet 64. Once the media interface module 16 is engaged with the printer frame 10 (as shown in FIG. 1), the first eyelet 56 and the second eyelet 64 are captured between the side walls 24 of the media interface module 16 and the adjacent side walls 34 of the printer frame 10 (as depicted in FIG. 5). As a result, the wiper member 40 is inhibited from disengaging the media interface module 16 as the wiper member 40 pivots during use.

With continued reference to FIGS. 4 and 5, one example biasing member 44 (in the form of an extension spring) is shown. The biasing member 44 is located in a cavity 76 defined by the side walls 24 of the media interface module 16. Each biasing member 44 has a first end 78 secured to a tab 80 that extends from the side wall 24. A second end 82 of the biasing member 44 engages a peg 84 that protrudes proximately from the respective first proximal end 52 of the first arm 46 and the second proximal end 62 of the second arm 48 (best shown in FIG. 5). As a result, an over-center arrangement is established that biases the wiper member 40 into either the engaged position (e.g., as shown in FIG. 6) or the disengaged position (e.g., as shown in FIG. 10).

Turning to FIGS. 6-10, as the media 12 is directed toward the print head (not shown), the wiper member 40 (more specifically the wiper pad 42) is urged or biased into engagement with the print surface 18 of the media 12 to attempt to remove debris. Beginning with FIG. 6, an essentially full roll of media 12 is shown being unwound from the spool assembly 14. The engagement between the print surface 18 of the media 12 and the wiper pad 42 urges the wiper member 40 upwards against the urging of the biasing member 44. As a result, the engagement of the wiper pad 42 on the print surface 18 removes at least a portion of any undesirable debris from the media 12.

As shown best in FIG. 8, the example wiper pad 42 has a generally rectangular cross-section 86 that defines an edge portion 88. The wiper member 40 is configured such that the edge portion 88, even when the spool assembly 14 includes the maximum amount of media 12, is spaced apart from the print surface 18. The slight angle θ ensures that the edge portion 88 of the wiper pad 42 does not undesirably engage certain types of media 12 (e.g., the leading edge of a die cut adhesive label media) and damage the media 12 prior to printing.

Returning to FIG. 7, as the media 12 is unwound from the spool assembly 14, the wiper member 40 rides along the print surface 18 of the media 12. The first arm 46 and the second arm 48 are biased and pivot counterclockwise, as shown in FIGS. 6 and 7, as the media 12 is unwound from the spool assembly 14 and eventually rest upon top surfaces 90 of the media interface module 16. As the media 12 is unwound from the spool assembly 14, the orientation of the wiper pad 42 is altered relative to the print surface 18 of the media 12. As best shown in FIG. 9, the angle φ established when the media 12 is nearly empty is greater than the angle θ established when the media 12 is essentially full (shown in FIG. 8). However, a portion of the wiper pad 42 continues to engage the print surface 18 of the media 12 even when the media 12 is nearly depleted from the spool assembly 14.

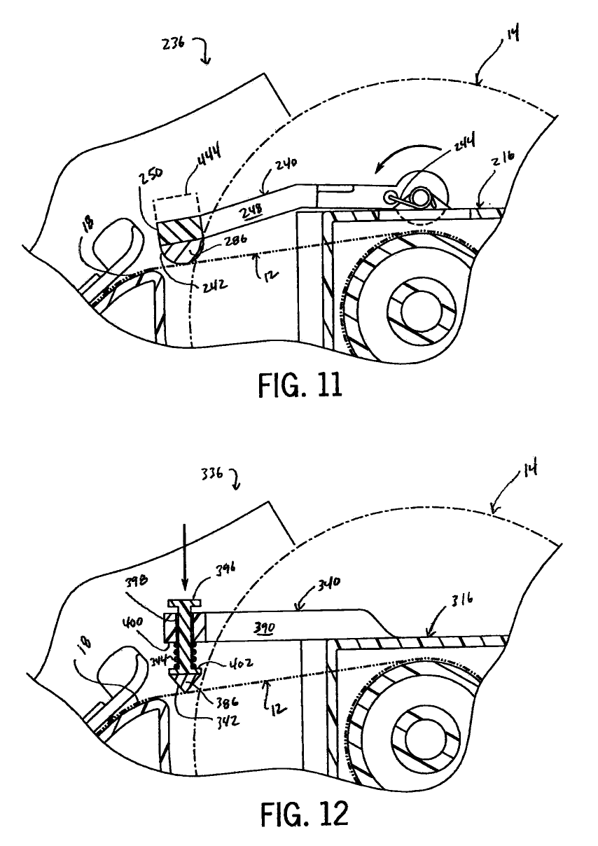

In certain circumstances, for example, when calibrating the position of the media 12 prior to the printer performing a print, the media 12 may be rewound or back fed onto the spool 15. The media wiper assembly 36 is preferably configured to accommodate this upstream movement of the media 12 and does not damage (i.e., bunch, ripple, crinkle, etc.) the media 12. For example, the biasing member 44 may be configured to accommodate back feeding of the media 12 by limiting the amount of bias of the wiper pad 42 into the media 12 (e.g., by limiting the tension provided by the extension springs) when the media 12 is being back fed toward the spool 15. Moreover, the arcuate contours of the wiper pad 242 shown in FIG. 11 and described in greater detail below, accommodate print media 12 being directed proximate the wiper pad 242 in either a feed direction (i.e., unwound from the spool 15) or a back feed direction (i.e., rewound to the spool 15). One skilled in the art, given the benefit of this disclosure, will appreciate the configurations available depending upon the specific application requirements.

The wiper member 40 is also capable of being pivoted clockwise (as shown in FIG. 10) such that the wiper member 40 is removed from the general location at which the media 12 must be accessed and fed into the print head. As a result, the wiper member 40 does not inhibit manually feeding media 12 toward the print head, such as is required during the installation of a different spool assembly 14.

Turning to FIG. 11, an alternative media wiper assembly 236 is shown. A wiper member 240 is pivotally coupled to the media interface module 216, similar to that described above; however a biasing member 244 comprises a torsion spring that engages the media interface module 216 and a single arm 248. That is, the wiper member 240 only has a single arm 248 engaging the media interface module 216, as opposed to the pair of arms previously discussed, resulting in a cantilevered wiper support 250. As with the first embodiment described, the biasing member 244 urges the wiper member 240 toward the print surface 18 of the media 12.

As another alternative to the spring-type biasing member, the biasing may be provided by the mass of the wiper member 240. This may be preferred in situations where the media 12 is highly sensitive and/or fragile (e.g., thin paper). Moreover, separate masses 444 (shown ghosted in FIG. 11) may be releasably coupled to the wiper member 240 (e.g., the arm 248 and/or a wiper support 250) in any quantity deemed necessary to provide additional downward or counterclockwise bias of the wiper member 240 toward the media 12. As a result, the term “biasing member” may comprise nothing more than the mass of the wiper member 240, may include additional masses 444 coupled to the wiper member 240, or any other form of biasing (e.g., extension spring, torsion spring, etc.).

A wiper pad 242 is again secured to the wiper support 250; however, as shown in FIG. 11, the wiper pad 242 has a generally semi-circular cross-section 286. This wiper pad 242 configuration reduces the potential for the wiper pad 242 to undesirably interact with the print surface 18 of the media 12 (e.g., peel a portion of an adhesive media away from a media substrate). Given the benefit of this disclosure, one skilled in the art will appreciate that a variety of arcuate cross-sections may be desirable as the application specifics require.

Yet another alternative media wiper assembly 336 is depicted in FIG. 12. As shown, a wiper member 340 is integrally formed with the media interface module 316. The wiper member 340 has a pair of L-shaped arms 390 that do not pivot. A wiper support 394 is coupled to a pair of alignment pins 396 that extend through two preferably evenly-spaced openings 398 formed through the arms 390. Alternatively, the arms 390 may be slideably coupled to a bridging member (not shown), generally forming a U-shaped wiper member, that extends between distal ends of linear arms 390. A biasing member 344 comprises a pair of springs captured between a bottom surface 400 of the arms 390 (or the bridging member) and an engagement surface 402 of the wiper support 394. A wiper pad 342 is again secured to the wiper support 394, however, as shown in FIG. 12, the wiper pad 342 has a generally triangular cross-section 386.

As a result, this media wiper assembly 336 configuration uses an integral wiper member 340 to support a wiper pad 342 that is biased toward the print surface 18 of the media as it is moveably suspended from the arms 390 of the wiper member 340. Again, one skilled in the art will appreciate, given the benefit of this disclosure, that a variety of alternative configurations (and wiper pad 342 cross-sections) are available given the requirements of each particular application.

While there has been shown and described what is at present considered the preferred embodiments of the invention, it will be obvious to those skilled in the art that various changes and modifications can be made, given the benefit of this disclosure, without departing from the scope of the invention defined by the following claims.

I claim:

1. A printer assembly, comprising:
a printer frame;
a media interface module disposed in the printer frame;
media disposed in the media interface module and dispensed from the media interface module into the printer frame;
a wiper member supported by one of the printer frame and the media interface module; and
a wiper pad carried by the wiper member and engaging the media to remove debris from the media.

2. The printer assembly of claim 1, further comprising a biasing member operatively engaging at least one of the wiper member and the wiper pad to bias the wiper pad toward the media when the media is directed proximate the wiper pad.

3. The printer assembly of claim 2, wherein the biasing member comprises an extension spring engaged with the media interface module and the wiper member.

4. The printer assembly of claim 2, wherein the biasing member comprises at least one of a mass of the wiper member and a separate mass coupled to the wiper member.

5. The printer assembly of claim 2, wherein the wiper member further comprises:
a first arm extending from the media interface module; and
a second arm extending from the media interface module;
wherein the wiper pad is supported by the first arm and the second arm; and
wherein the biasing member is operatively engaged between at least one of the first arm and the second arm, and the wiper pad to bias the wiper pad away from the first arm and the second arm.

6. The printer assembly of claim 1, wherein the wiper member is pivotally supported by at least one of the printer frame and the media interface module.

7. The printer assembly of claim 1, wherein the wiper member is fixed to at least one of the printer frame and the media interface module.

8. The printer assembly of claim 1, wherein the wiper pad defines a cross-section, and wherein the cross-section is at least one of a rectangular cross-section, an arcuate cross-section, and a triangular cross-section.

9. The printer assembly of claim 1, wherein the wiper pad includes an edge portion that is spaced apart from a print surface defined by the media when the wiper pad engages the print media.

10. The printer assembly of claim 1, wherein the wiper member further comprises:
a first arm having a distal end and a proximal end, the proximal end supported by the media interface module; and
a wiper support extending from the distal end of the first arm and carrying the wiper pad.

11. The printer assembly of claim 10, wherein the wiper member further comprises:
a second arm having a proximal end supported by the media interface module and a distal end engaging the wiper support;
wherein the first arm and the second arm are pivotally supported by the media interface module.

12. A media interface module, comprising:
media disposed in the media interface module;
a wiper member supported by the media interface module; and
a wiper pad carried by the wiper member and engaging the media to remove debris from the media as the media is dispensed form the media interface module.

13. The media interface module of claim 12, wherein the wiper member further comprises:
a first arm having a distal end and a proximal end, the proximal end is pivotally coupled to the media interface module; and
a second arm having a distal end and a proximal end, the proximal end is pivotally coupled to the media interface module.

14. The media interface module of claim 13, wherein the wiper member further comprises a wiper support secured between the distal end of the first arm and the distal end of the second arm, wherein the wiper pad is carried by the wiper support and configured to engage the media when the media is directed proximate the wiper pad.

15. The media interface module of claim 13, further comprising a biasing member operatively engaging at least one of the first arm and the second arm, and the media interface module.

16. The media interface module of claim 15, wherein the biasing member includes at least one of an extension spring and a torsion spring.

17. The media interface module of claim 12, wherein the wiper pad defines a cross-section, and wherein the cross-section is at least one of a rectangular cross-section, an arcuate cross-section, and a triangular cross-section.

18. The media interface module of claim 12, wherein the wiper pad includes an edge portion that is spaced apart from a print surface defined by the media when the wiper pad engages the media.
